(19) United States
(12) Patent Application Publication
(10) Pub. No.: US 2022/0360125 A1
(43) Pub. Date: Nov. 10, 2022

(54) ROTOR FOR AN ELECTRIC MACHINE

(71) Applicant: Mahle International GmbH, Stuttgart (DE)

(72) Inventors: Andrej Cernigoj, Ajdovscina (SI); Nejc Volk, Sezana (SI); Blaz Vitez, Ajdovscina (SI)

(21) Appl. No.: 17/732,512

(22) Filed: Apr. 28, 2022

(30) Foreign Application Priority Data
May 10, 2021 (EP) 21000128.5

(51) Int. Cl. H02K 1/2753; H02K 15/03

(52) U.S. Cl. CPC H02K 1/2753; H02K 15/03

(57) ABSTRACT

A rotor for an electric machine may include a stack of ferrous laminations and a rotor core. The stack may be divided into a plurality of segments in a circumferential direction. At least one permanent magnet may be arranged between two adjacent segments of the plurality of segments. Each of the plurality of segments may have an opening extending in a radial direction outwards from a radially inner surface. The rotor core may connect the two adjacent segments. The rotor core may be formed via casting a non-ferrous material in a space disposed radially inwards of the plurality of segments and into the radially outwards extending opening of each of the plurality of segments. The opening of each of the plurality of segments may have a generally fir-tree shaped section profile.

### CROSS-REFERENCE TO RELATED APPLICATIONS

This application claims priority to European Patent Application No. EP21000128.5, filed on May 10, 2021, the contents of which is hereby incorporated by reference in its entirety.

### TECHNICAL FIELD

The invention relates to a rotor for an electric machine. The invention furthermore relates to a method for manufacturing a rotor for an electric machine.

### BACKGROUND

Spoke-type permanent magnet rotors are used in brushless direct current motors and/or permanent magnet synchronous motors forming the rotating part inside the stationary stator, with an air gap between the inner surface of the stator and the outer surface of the rotor. The spoke-type rotor comprises a stack of steel laminations which hold the permanent magnets. The permanent magnets extend in a radial direction with respect to the center of rotation of the rotor and are arranged between adjacent segments of the steel laminations, similar to the spokes of a wheel, hence the name “spoke-type”. Each steel lamination can either be made in one-piece or alternatively the steel lamination segments can be separated in the circumferential direction. If the steel laminations are made in one-piece, this has negative implications on the magnetic circuit. If the segments of the steel laminations are separated in the circumferential direction, each segment must be fixed to the shaft in such a way as to withstand the radial forces acting on it.

A known prior art spoke-type permanent magnet rotor with segmented laminations is disclosed in US4504755A. This describes a method of attaching the steel laminations to the shaft by providing the steel laminations with a set of openings which extend radially into the laminations and end in an enlarged triangular shaped space. Molten aluminum is cast into the openings and into the gap between the steel laminations and the shaft in order to fix the laminations with respect to the shaft. In this case the steel lamination segments are initially joined together and subsequently separated. A similar method is disclosed in US3979821A, whereby the openings which extend radially into the laminations end in an enlarged circular space.

### SUMMARY

The rotor according to the invention as defined in independent claim 1 and a method of manufacturing a rotor for an electric machine as defined in independent claim 12 has the advantage that stress concentrations are reduced in a region between the lamination segments and the cast rotor core which holds the segments together.

This is achieved according to a first aspect of the invention with a rotor for an electric machine comprising a stack of ferrous laminations, the stack is divided into segments in the circumferential direction, whereby at least one permanent magnet is arranged between two adjacent segments, each segment comprising an opening extending in a radial direction outwards from a radially inner surface, a rotor core is provided for connecting the adjacent segments, whereby the rotor core is formed by casting or molding a non-ferrous material, in particular a non-ferrous metal, in a space radially inwards of the lamination segments and into the radially outwards extending openings in each of the lamination segments, whereby the openings have a generally fir-tree shaped section profile.

The fir-tree shaped profile of the openings in the lamination enables a large bearing area to take up the stresses caused by the centrifugal load acting on the cast rotor core. A fir-tree profile has a radially extending central portion with branches extending generally perpendicularly therefrom. Surfaces of the opening section profile which have a component facing away from the axis of rotation of the rotor are subject to centrifugal loading and the fir-tree profile maximizes the area of these surfaces, therefore minimizing stress concentrations. Therefore, for a given load bearing capability, the area of the opening section profile can be reduced compared with prior art designs, so that the amount of casting material can be minimized.

In one embodiment the generally fir-tree shaped section profile comprises at least a first radially outer branch and a first radially inner branch, whereby the first radially outer branch has a radially inner side which extends in a direction perpendicular to the radial direction from a minimum branch thickness T1 to a maximum branch thickness L1, and the first radially inner branch has a radially inner side which extends in a direction perpendicular to the radial direction from a minimum branch thickness T2 to a maximum branch thickness L2. The branch thickness is measured from the radially extending profile reference line, which is defined as a straight line running through the rotor centerpoint and a centroid point of the fir-tree shaped profile. The centroid of the fir-tree shaped profile is the geometric centre of the area enclosed by the fir-tree profile and a line which extends across the radially inner opening at the narrowest point. In the case of a fir-tree profile with more than two branches on one side, the radially outer and radially inner branch are to be understood to refer to the radially outermost two branches.

The radially inner side of the first inner branch extends in a line from the minimum branch thickness T2 to the maximum branch thickness L2, whereby the line has a tangent having a maximum angle β with respect to the profile reference line, and the radially inner side of the first outer branch extends in a line from the minimum branch thickness T1 to the maximum branch thickness L1, whereby the line has a tangent having a maximum angle α with respect to the profile reference line, whereby α is in the range of 10° to 60° , and β≤90°, and whereby β/α is in the range of 1.2 to 5.

It has been found that having the ratio of the angles α and β within this range enables the load to be evenly applied between the two branches. As the radially outer branch is subject to higher loads the stresses can be reduced by reducing the angle α compared to the radially inner branch or branches. In a particularly advantageous embodiment α is in the range of 40° to 60°, and β is in the range of 60° to 80°.

The relationship between the minimum branch thicknesses T1,T2 to the respective maximum branch thicknesses L1,L2 is advantageously in the range 1.2≤L1/T1≤1.8 and 1.5≤L2/T2≤2.0, and the relationship between the maximum branch thicknesses (L1,L2) is in the range 0.5≤L1/L2≤2.0. The combination of these features provides a geometry with less stress concentrations. More preferably 1.4≤L1/T1≤1.6 and 0.7≤L1/L2≤1.0, in this case the radially inner branch extends further in the direction perpendicular to the radial direction than the radially outer branch. As the radially outer brand does not extend as far in the perpendicular direction it does not interfere as much with the magnetic flux from the magnet and therefore increases the efficiency of the motor.

The radially inner side of the first inner branch can comprise a substantially straight portion which extends along a substantial length (B) of the radially inner side, and the radially inner side of the first outer branch comprises a substantially straight portion which extends along a substantial length (A) of the radially inner side. In an advantageous embodiment the ratio of the length A to the length B of the straight portions are in the range 0.3≤B/A≤0.75, and preferably in the range 0.4≤B/A≤0.6. This enables the radii of the fir-tree profile at the radially inner region of the opening to be larger, thus reducing stress concentrations at the more critical area in the laminations.

The ratio of the length (A) to L1 is in the range 0.2≤A/L1≤0.4, and the ratio of the length (B) to L2 is in the range 0.05≤B/L2≤0.25, preferably 0.06≤B/L2≤0.11. These ratios enable the fir-tree profile to have sufficiently large radii to reduce stress concentrations in the laminations and the casting material whilst maintaining sufficient load bearing capacity and enables the casting material to fill the opening without voids.

In one preferred embodiment, the ratio T2/T1 of the minimum branch thickness T2 to the minimum branch thickness T1 is in the range 0.90≤T2/T1≤1.25. A ratio within this range has been found to contribute to further evening of the stress distribution between the two branches. In a more preferred embodiment, T2/T1>1.05. The distance H1 is the distance measured in the radial direction 11 from the point of the minimal branch thickness T1 of the outer branch 14a to the radially outer tip 18 of the section profile 13. The ratio T1/H1 is in the range of 0.50≤T1/H1≤0.9, and in the preferred embodiment the T1/H1=0.7. These relationships allow for a relatively large minimal branch thickness T1,T2 in relation to H1 which contributes to better durability of aluminium casted core.

The rotor core is generally ring-shaped with a central opening which receives a rotor shaft. Alternatively the rotor core can form itself part of the shaft. The rotor core has radial projections which project radially outwards into the openings in each respective segment.

The rotor core is preferably made of a cast non-ferrous metal, in particular aluminium or aluminium alloy. The cast non-ferrous metal takes the shape of the generally fir-tree shaped section profile when cast into the openings of the segments. This has the advantage over using a machined fir-tree profile that machining tolerances do not need to be accounted for and the surface of the opening in each segment is in direct contact with the rotor core so that stress concentrations are reduced. Alternatively the rotor core can be made out of a plastic material and molded into the openings of the segments, this has the advantage of reduced weight.

In a further aspect of the invention a method for manufacturing a rotor for an electric machine is provided, the method comprising providing a stack of ferrous laminations, the laminations being segmented in the circumferential direction, and with at least one permanent magnet arranged between two adjacent segments, whereby each segment comprises an opening extending in a radial direction outwards from a radially inner surface, whereby the opening has a generally fir-tree shaped section profile, and casting a molten non-ferrous metal into a space radially inwards of the lamination segments and into the radially outwards extending openings in each of the lamination segments to connect adjacent segments together. The fir-tree shaped section profile can have any of the dimensions described with respect to the rotor according to the invention.

In a further advantageous embodiment, each segmented lamination is initially formed as one piece, and after the step of casting the non-ferrous metal core, adjacent segments are subsequently separated by removing material from the laminations by machining. In this way the manufacturing of the rotor is simplified as the segments do not need aligning with respect to each other, instead the complete stack of laminations can be stacked and aligned together before casting the non-ferrous metal core which holds the segments in position when the segments are subsequently separated in order to improve the magnetic flux.

### BRIEF DESCRIPTION OF THE DRAWINGS

Embodiments will now be described by way of example only with reference to the accompanying drawings, in which:

FIG. 1 is a sectional view of a rotor according to the invention,

FIG. 2 is an enlarged sectional view of one of the radially outwards extending openings of FIG. 1.

### DETAILED DESCRIPTION

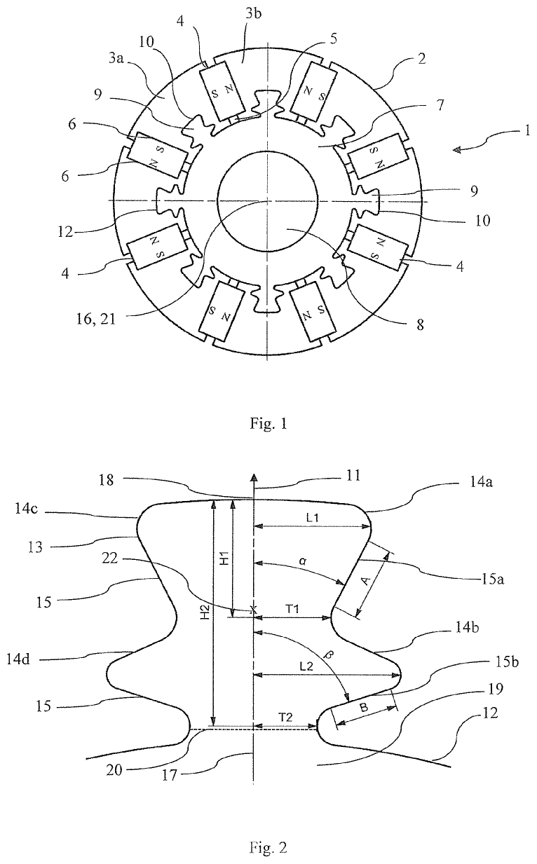

Referring to FIGS. 1 and 2, FIG. 1 shows a sectional view in the axial direction of a rotor 1 for an electric machine according to one embodiment of the invention. The rotor 1 rotates around a rotational axis 16 and comprises a plurality of ferrous laminations 2 which are stacked one on top of another in the axial direction of the rotor 1. The ferrous laminations 2 are divided into a plurality of segments 3a, 3b etc. in the circumferential direction. In the embodiment shown in FIG. 1 there are eight such segments 3. Each segment therefore comprises a stack of laminations 2. At least one permanent magnet 4 is arranged between each pair of adjacent segments 3a, 3b. The permanent magnet 4 is arranged with its poles facing the circumferential direction and is received in a recess 6 in each segment 3a, 3b of a pair of lamination segments 3a, 3b. In permanent magnet motors of the spoke type it is desirable to minimize a magnet flux on the radially inner side of the permanent magnets, so that the magnetic flux is concentrated in the radially outer region of the rotor. In the embodiment shown in FIG. 1 there is a gap 5 between each pair of adjacent lamination segments 3 radially inwards of the permanent magnets 4 so that the ferrous laminations 2 do not provide a low resistance path for the magnetic flux between the poles of the magnets 4 in this area.

A rotor core 7 is provided for holding and connecting the lamination segments 3. The rotor core 7 is generally ring-shaped with a central opening 8 which receives a rotor shaft (not shown). Alternatively, the rotor core 7 can form itself part of the shaft. Each segment 3 comprises an opening 10 extending in a radial direction 11 outwards from a radially inner surface 12, and the rotor core 7 has radial projections 9 which project radially outwards into the openings in each respective segment 3. The rotor core 7 is made of a cast non-ferrous metal, in particular aluminium or aluminium alloy and is formed by casting the non-ferrous metal in a space radially inwards of the lamination segments and into the radially outwards extending openings 10 in each of the lamination segments 3. The openings 10 have a generally fir-tree shaped section profile 13 and the cast non-ferrous metal takes the shape of the generally fir-tree shaped section profile 13 when cast into the openings 10 of the segments 3. As the radial projections 9 take the shape of the fir-tree shaped section profile 13 the radial projections 9 of rotor core 7 are in contact with the surface of the openings 10 along the whole of the profile 13, fixing the segments 3 to the rotor core 7.

Each segmented lamination 2 can be initially formed as one piece i.e. the segments 3 are initially joined together, and after the step of casting the non-ferrous metal core, adjacent segments 3a, 3b are subsequently separated by removing material from the laminations 2 by machining. In this way the manufacturing of the rotor is simplified as the segments 3 do not need aligning with respect to each other, instead the complete stack of laminations 2 can be stacked and aligned together before casting the non-ferrous metal core which holds the segments in position when the segments are subsequently separated in order to improve the magnetic flux.

The fir-tree shaped profile 13 of the openings 10 enables a large bearing area to take up the stresses caused by the centrifugal load acting on the cast rotor core 7. As can be seen in FIG. 2, which shows an enlarged portion of one of the segments 3, a fir-tree profile has a central portion extending in the radial direction 11 with branches 14a, 14b extending generally perpendicularly therefrom. Surfaces 15 of the openings 10 which are defined by the parts of the section profile 13 which have components facing away from the axis of rotation 16 of the rotor are subject to centrifugal loading and the fir-tree profile 13 maximizes the area of the these surfaces 15, therefore minimizing stress concentrations. Therefore, for a given load bearing capability, the cross-sectional area of the opening section profile 13 can be reduced compared with prior art designs, so that the amount of casting material can be minimized.

To avoid stress concentrations in the radial projection 9 of the rotor core 7 it is important to distribute the load evenly between the branches of the fir-tree profile 13. At the same time, it is important that the openings 10 in the lamination segments 3 do not negatively affect the magnetic flux. The inventors have found that the relative dimensions of the branches 13 can be chosen to obtain an improved stress distribution without detriment to the magnetic flux.

In the embodiment shown in FIG. 2 the generally fir-tree shaped section profile 13 comprises a first radially outer branch 14a which extends in a direction perpendicular to the radial direction 11. The outer branch 14a has a radially inner side 15a which extends in a direction perpendicular to the radial direction 11 from a minimum branch thickness T1 to a maximum branch thickness L1, whereby the minimum branch thickness T1 and the maximum branch thickness L1 is the distance measured in a direction perpendicular to the radial direction 11 from the profile reference line 17. Similarly, the first radially inner branch 14b has a radially inner side 15b which extends in a direction perpendicular to the radial direction 11 from a minimum branch thickness T2 to a maximum branch thickness L2. In the embodiment shown, the generally fir-tree shaped section profile 13 is symmetric about the profile reference line 17 such that there are four branches (14a-d).

The profile reference line 17 is defined as a straight line running through the rotor centerpoint 21 and a centroid point 22 of the fir-tree shaped section profile 13. The centroid 22 of the fir-tree shaped profile 13 is the geometric center of the area enclosed by the fir-tree profile 13 and a line 20 which extends across the radially inner opening at the narrowest point.

The radially inner side 15b of the first inner branch 14b extends in a line from the minimum branch thickness T2 to the maximum branch thickness L2, whereby the line has a tangent having a maximum angle β with respect to the profile reference line 17. The radially inner side 15a of the first outer branch 14a extends in a line from the minimum branch thickness T1 to the maximum branch thickness L1, whereby the line has a tangent having a maximum angle α with respect to the profile reference line 17. According to one embodiment of the invention, α is in the range of 10° to 60°, and β≤90°, and β/α is in the range of 1.2 to 5. According to a more preferred embodiment of the invention a is in the range of 40° to 60° , and β is in the range of 60° to 80° . Having the ratio of the angles α and β within this range enables the load to be evenly applied between the two branches 14a and 14b. As the radially outer branch 14a is subject to higher loads, the stresses can be reduced by reducing the angle α compared to the angle β of the radially inner branch or branches 14b, 14d.

The relationship between the minimum branch thicknesses T1,T2 to the respective maximum branch thicknesses L1,L2 is in the range 1.2≤L1/T1≤1.8 and 1.5≤L2/T2≤2.0, and the ratio of the maximum branch thickness L1 of the first radially outer branch 14a to the maximum branch thickness L2 of the first radially inner branch 14b, L1/L2, is in the range of 0.5≤L1/L2≤2.0. The combination of these features provides a geometry with less stress concentrations. More preferably 1.4≤L1/T1≤1.6 and 0.7≤L1/L2≤1.0.

The radially inner side 15b of the first inner branch 14b comprises, in the embodiment shown in FIG. 2, a substantially straight portion which extends along a substantial length (B) of the radially inner side 15b, and the radially inner side 15a of the first outer branch 14a comprises a substantially straight portion which extends along a substantial length (A) of the radially inner side 15a. The ratio of the length A to the length B of the straight portions are in the range 0.3≤B/A≤0.75, and preferably in the range 0.4≤B/A≤0.6. The ratio of the length (A) to L1 is in the range 0.2≤A/L1≤0.4, and the ratio of the length (B) to L2 is in the range 0.05≤B/L2≤0.25, preferably 0.06≤B/L2≤0.11. These ratios enable the fir-tree profile to have sufficiently large radii to reduce stress concentrations and enabling the casting material to fill the opening without voids between the openings 10 of the segments 3 and the radial projections 9 of the rotor core 7.

The ratio T2/T1 of the minimum branch thickness T2 to the minimum branch thickness T1 is in the range 0.90≤T2/T1≤1.25. A ratio within this range has been found to contribute to further evening of the stress distribution between the two branches. In the preferred embodiment, T2/T1 is 1.1. The distance H1 is the distance measured in the radial direction 11 from the point of the minimal branch thickness T1 of the outer branch 14a to the radially outer tip 18 of the section profile 13. The ratio T1/H1 is in the range of 0.50≤T1/H1≤0.9, and in the preferred embodiment the T1/H1=0.7. These relationships allow for a relatively large minimal branch thickness T1,T2 in relation to H1 which contributes to better durability of aluminium casted core.

As can be seen in the FIG. 2, the radially inner branch 14b extends further in the direction perpendicular to the radial direction 11 than the radially outer branch 14a. As the radially outer branch does not extend as far in the perpendicular direction it does not interfere as much with the magnetic flux from the magnet 4 and therefore increases the efficiency of the motor.

The preceding description of the fir tree profile 13 according to the invention can apply to either side of a fir-tree profile, i.e. the left or right side if the profile is asymmetric, or to both sides if the profile is symmetric.

The invention is applicable to rotors for electric machines, including motors or generators.

### LIST OF REFERENCE NUMERALS

1. Rotor
2. Ferrous laminations
3. Lamination segment
4. Permanent magnet
5. Gap
6. Recess
7. Rotor core
8. Central opening
9. Radial projection
10. Opening
11. Radial direction
12. Radially inner surface
13. fir-tree shaped section profile
14. Branches: First branch (a), second branch (b)
15. Surface with components facing away from rotation axis
16. Rotation axis
17. Profile reference line
18. Tip
19. Space
20. Profile border line
21. Rotor centerpoint
22. Centroid point

1. A rotor for an electric machine, comprising; a stack of ferrous laminations, the stack divided into a plurality of segments in a circumferential direction;
at least one permanent magnet arranged between two adjacent segments of the plurality of segments;
each of the plurality of segments having an opening extending in a radial direction outwards from a radially inner surface;
a rotor core for connecting the two adjacent segments;
wherein the rotor core is formed via casting a non-ferrous material in a space disposed radially inwards of the plurality of segments and into the radially outwards extending openings of each of the plurality of segments; and
the openings of each of the plurality of segments has a generally fir-tree shaped section profile.

2. The rotor according to claim 1, wherein:
the generally fir-tree shaped section profile includes at least a first radially outer branch and a first radially inner branch;
the first radially outer branch has a radially inner side extending in a direction perpendicular to the radial direction from a minimum branch thickness T1 to a maximum branch thickness L1; and
the first radially inner branch has a radially inner side extending in the direction perpendicular to the radial direction from a minimum branch thickness T2 to a maximum branch thickness L2.

3. The rotor according to claim 2, wherein:
the radially inner side of the first inner branch extends in a line from the minimum branch thickness T2 to the maximum branch thickness L2;
the line of the radially inner side of the first inner branch has a tangent having a maximum angle β with respect to a profile reference line; and
the radially inner side of the first outer branch extends in a line from the minimum branch thickness T1 to the maximum branch thickness L1;
the line of the radially inner side of the first outer branch has a tangent having a maximum angle α with respect to the profile reference;
α is in a range of 10° to 60° and β≤90°; and
β/α is in a range of 1.2 to 5.

4. The rotor according to claim 3, wherein:
α is in a range of 40° to 60°; and
β is in a range of 60° to 80°.

5. The rotor according to claim 3, wherein:
a relationship between the minimum branch thicknesses to the respective maximum branch thicknesses is in a range 1.2≤L1/T1≤1.8 and 1.5≤L2/T2≤2.0; and
a relationship between the maximum branch thicknesses is in a range 0.5≤L1/L2≤2.0.

6. The rotor according to claim 5, wherein the that the relationship between the maximum branch thicknesses is in a range 0.7≤L1/L2≤1.0.

7. The rotor according to claim 3, wherein:
the radially inner side of the first inner branch includes a substantially straight portion which extends along a substantial length B of the radially inner side of the first inner branch:
the radially inner side of the first outer branch includes a substantially straight portion which extends along a substantial length A of the radially inner side of the first outer branch; and
a ratio of the length A to the length B of the straight portions is in a range 0.3≤B/A≤0.75.

8. The rotor according to claim 7, wherein:
a ratio of the length A to the maximum branch thickness L1 is in a range 0.2≤A/L1≤0.4; and
a ratio of the length B to the maximum branch thickness L2 is in a range 0.05≤B/L2≤0.25.

9. The rotor according to claim 2, wherein the radially inner branch extends further in the direction perpendicular to the radial direction than the radially outer branch.

10. The rotor according to claim 2, wherein:
a ratio T1/H1 is in a range of 0.50≤T1/H1≤0.9;
a ratio T2/T1 is in a range of 0.90≤T2/T1≤1.25; and
H1 is a distance measured in the radial direction from a point of the minimum branch thickness T1 of the first radially outer branch to a radially outer tip of the section profile.

11. The rotor according to claim 1, wherein the rotor core is generally ring-shaped.

12. A method for manufacturing a rotor for an electric machine, the method comprising:
providing a stack of ferrous laminations, the stack being divided into a plurality of segments in the circumferential direction, and with at least one permanent magnet arranged between two adjacent segments of the plurality of segments, each of the plurality of segments having an opening extending in a radial direction outwards from a radially inner surface, the opening of each of the plurality of segments having a generally fir-tree shaped section profile; and
casting a molten non-ferrous metal into a space disposed radially inwards of the plurality of segments and into the radially outwards extending openings of each of the plurality of segments to connect adjacent segments of the plurality of segments together.

13. The method according to claim 9, wherein:
the plurality of segments are initially formed as one piece; and
the method further comprises, after casting the non-ferrous metal core, separating adjacent segments of the plurality of segments via removing material from the laminations by machining.

14. A rotor for an electric machine, comprising:
a stack of ferrous laminations, the stack divided in a circumferential direction into a plurality of segments;
each segment of the plurality of segments having a radially inner surface and an opening disposed in the radially inner surface, the opening projecting into the segment in a radial outwards direction and having a radial cross-section that defines a generally fir-tree shaped profile;
a plurality of permanent magnets each of which are arranged between a respective pair of adjacent segments of the plurality of segments;
a rotor core including a plurality of radial projections protruding radially outward therefrom, the plurality of radial projections each having a radial cross-section that defines a generally fir-tree shaped profile;
wherein the plurality of segments are disposed circumferentially around the rotor core and are connected to the rotor core; and
wherein each of the plurality of radial projections is arranged in the opening of an associated segment of the plurality of segments and connects the associated segment to the rotor core.

15. The rotor according to claim 14, wherein the generally fir-tree shaped profile includes:
an open end and a closed end;
a first branch extending transversely to a profile reference line extending radially through a centroid point of the generally fir-tree shaped profile, the first branch disposed adjacent to the closed end;
a second branch extending transversely to the profile reference line and disposed adjacent to the open end;
a first maximum branch thickness defined between an apex of a first curve of the first branch and the profile reference line;
a second maximum branch thickness defined between an apex of a second curve of the second branch and the profile reference line;
a third curve connecting the first branch and the second branch;
a fourth curve connecting the second branch and the radially inner surface;
a first minimum branch thickness defined between an apex of the third curve and the profile reference line; and
a second minimum branch thickness defined between an apex of the fourth curve and the profile reference line.

16. The rotor according to claim 15, wherein:
a ratio of the first maximum branch thickness to the first minimum branch thickness is from 1.2 ; to 1.8;
a ratio of the second maximum branch thickness to the second minimum branch thickness is from 1.5 to 2.0; and
a ratio of the first maximum branch thickness to the second maximum branch thickness is from 0.5 to 2.0.

17. The rotor according to claim 15, wherein:
the first branch includes a first linear portion extending between and connecting the first curve and the third curve;
the second branch includes a second linear portion extending between and connecting the second curve and the fourth curve;
a first angle defined between the first linear portion and the profile reference line is from 10° to 60°; and
a second angle defined between the second linear portion and the profile reference line is 90° or less.

18. The rotor according to claim 17, wherein:
the first linear portion has a first length;
the second linear portion has a second length; and
a ratio of the second length to the first length is from 0.3 to 0.75.

19. The rotor according to claim 7, wherein the ratio of the length A to the length B of the straight portions is in a range 0.4≤B/A≤0.6.

20. The rotor according to claim 8, wherein the ratio of the length B to the maximum branch thickness L2 is in a range 0.06≤B/L2≤0.11.
